(19) United States
(12) Patent Application Publication
(10) Pub. No.: US 2011/0161961 A1
(43) Pub. Date: Jun. 30, 2011

(54) METHOD AND APPARATUS FOR OPTIMIZED INFORMATION TRANSMISSION USING DEDICATED THREADS

(75) Inventor: Yan Fu, Espoo (FI)

(73) Assignee: Nokia Corporation, Espoo (FI)

(21) Appl. No.: 12/648,825

(22) Filed: Dec. 29, 2009

(51) Int. Cl. G06F 9/46; G06F 15/16

(52) U.S. Cl. 718/102

(57) ABSTRACT

An approach is provided for optimized information transmission using dedicated threads. A thread manager receives a request from a device for content information. The thread manager assigns the request to a worker thread for processing to generate the content information. The thread manager further determines whether the worker thread has completed the processing of the content information. The thread manager delegates the processed content information to a transmission thread based, at least in part, on the determination, wherein the transmission thread causes, at least in part, transfer of the processed content information. The thread manager releases the worker thread from the assigned request.

### BACKGROUND

Network service providers and device manufacturers are continually challenged to deliver value and convenience to consumers by, for example, providing compelling network services. In particular, many of these network services rely on the web-based technologies and supporting communication networks, leading to a great increase in the popularity of such services. As a result, web server hardware technologies have also seen rapid improvements and are becoming increasingly sophisticated and capable, leading to faster response and processing of client requests. Moreover, the increased popularity of these web services has further extended to mobile devices (e.g., smartphones, handsets, portable computers, etc.) that have connectivity over wireless networks (e.g., cellular networks). For example, mobile device users commonly demand services offering rich content (e.g., audio and video) over wireless networks. However, such data-intensive services place great demands on network resources (e.g., bandwidth, processor resources, etc.), particularly in a wireless network environment. Accordingly, service providers and device manufacturers face significant technical challenges in providing data-intensive web services to the growing population of users and reconciling the faster response times of modern web servers with the network bandwidth limitations.

### SOME EXAMPLE EMBODIMENTS

Therefore, there is a need for an approach for optimizing the efficiency and resource utilization of information transmissions from servers.

According to one embodiment, a method comprises receiving a request from a device for content information. The method also comprises assigning the request to a worker thread for processing to generate the content information. The method also comprises determining whether the worker thread has completed the processing of the content information. The method further comprises delegating the processed content information to a transmission thread based, at least in part, on the determination. The transmission thread causes, at least in part, transfer of the processed content information. The method also comprises releasing the worker thread from the assigned request.

According to another embodiment, an apparatus comprising at least one processor, and at least one memory including computer program code, the at least one memory and the computer program code configured to, with the at least one processor, cause, at least in part, the apparatus to receive a request from a device for content information. The apparatus is also caused to assign the request to a worker thread for processing to generate the content information. The apparatus is further caused to determine whether the worker thread has completed the processing of the content information. The apparatus is further caused to delegate the processed content information to a transmission thread based, at least in part, on the determination. The transmission thread causes, at least in part, transfer of the processed content information. The apparatus is further caused to release the worker thread from the assigned request.

According to another embodiment, a computer-readable storage medium carrying one or more sequences of one or more instructions which, when executed by one or more processors, cause, at least in part, an apparatus to receive a request from a device for content information. The apparatus is also caused to assign the request to a worker thread for processing to generate the content information. The apparatus is further caused to determine whether the worker thread has completed the processing of the content information. The apparatus is further caused to delegate the processed content information to a transmission thread based, at least in part, on the determination. The transmission thread causes, at least in part, transfer of the processed content information. The apparatus is further caused to release the worker thread from the assigned request.

According to another embodiment, an apparatus comprises means for receiving a request from a device for content information. The apparatus also comprises means for assigning the request to a worker thread for processing to generate the content information. The apparatus further comprises means for determining whether the worker thread has completed the processing of the content information. The apparatus further comprises means for delegating the processed content information to a transmission thread based, at least in part, on the determination. The transmission thread causes, at least in part, transfer of the processed content information. The apparatus also comprises means for releasing the worker thread from the assigned request.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing optimized information transmission using dedicated threads, according to one embodiment;

FIG. 2 is a diagram of the components of thread manager, according to one embodiment;

FIG. 3 is a flowchart of a process for providing optimized information transmission using dedicated threads, according to one embodiment;

FIG. 4 is a flowchart of a thread management process for providing optimized information transmission using dedicated threads, according to one embodiment;

FIGS. 5A-5B illustrate utilization of transmission threads, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for optimized information transmission by assigning dedicated threads are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “thread” refers to information processing components of a server. Although various embodiments are described with respect to threads, it is contemplated that the approach described herein may be used with other processes or modules.

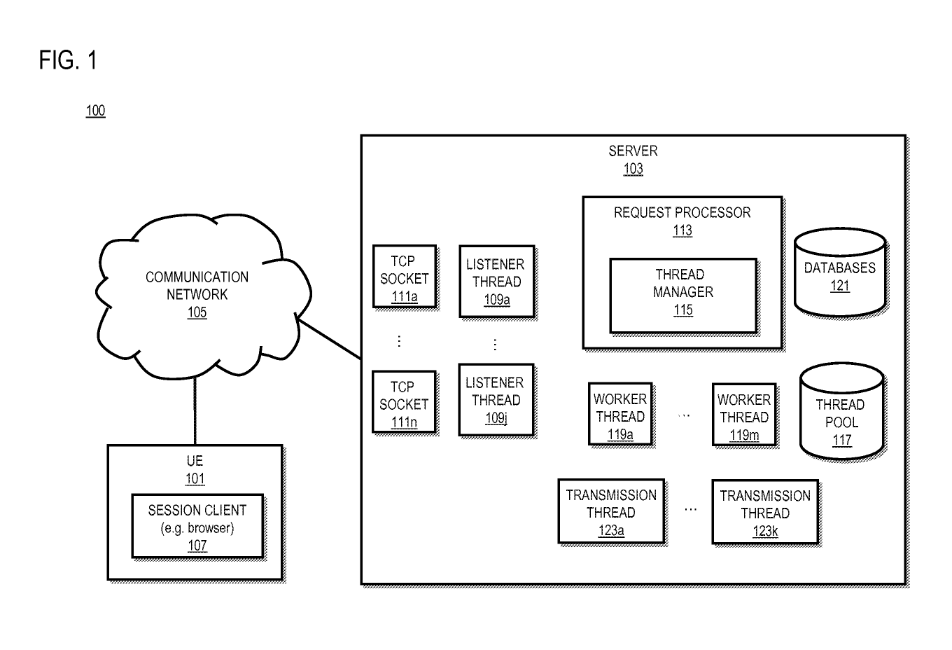

FIG. 1 is a diagram of a system capable of providing optimized information transmission by assigning dedicated threads, according to one embodiment. Generally, the processes within the scope of traditional network server environments consist of multiple sub-processes or processing components often referred to as threads. For example, one or more threads (listener threads) are in charge of detecting incoming requests by constant monitoring of the transmission protocol interface (e.g., TCP socket). When an incoming request from a client is received, the listener thread launches a new thread or selects an existing thread from a thread pool to process the request (worker thread). The server assigns a worker thread to a client request according to factors such as communication speed, request priority, client's level of authority, request history, etc. In current network communication protocols, the worker thread assigned to a request, generates a response to the request by, for instance, collecting information from data stores connected to the network and by processing the collected data. When a response is generated, the worker thread that generated the response also is typically tasked with transmitting the response to the requesting client. In such a scenario, the worker thread will remain assigned to the specific request until the response is transmitted to the requesting client. Once the response is delivered, the listener thread either kills the worker thread or adds the thread to a thread pool for further use.

However, this conventional process is not optimized for serving a large number of requests, particularly, from a growing number of mobile devices connected over wireless networks where bandwidth and other network resources can be limited. Moreover, it is noted that the communication speed between client (e.g., mobile devices) and server remains relatively slower than server computational speeds because of the generally slower development and deployment of wireless telecommunication networks. In other words, the process of response generation is typically much faster (e.g., due to advances in modern web server technologies) than response transmission (e.g., due to limitations caused by increasing demand from more devices on available network bandwidth and/or transmission speeds). Accordingly, the typical worker thread can process a request relatively quickly, but will likely remain idle or otherwise underutilized while waiting for transmission of the processed request to the client. It is further noted that with improvements in user equipment capabilities and the growing popularity of web services offering rich content, larger responses are expected to be generated and transmitted, thereby making the disparity between the processing time and the transmission time for responding to a client request even larger. Therefore, the current or traditional method for using threads is not optimized, especially in situations where there are a large number of requests from clients to be processed.

For example, it is noted that the time a worker thread spends on generation a response to a request (e.g., HTTP request) is relatively shorter than the time the thread spends on response transmission. When a large number of concurrent requests arrive at a server, the server will be quickly saturated by a large number of active worker threads, which spend a large portion of their time on response transmission rather than response generation. This may unnecessarily keep server resources (e.g., worker threads) idle while waiting for transmissions to be completed.

To address this problem, a system 100 of FIG. 1 introduces the capability use dedicated transmission threads to offload the responsibility of transmitting responses from the worker threads. In one embodiment, as each worker thread completes response generation, the worker thread delegates the task of transmitting the response to a dedicated transmission thread. In this way, the worker thread can be assigned to a new request or killed to free up processing resources. Furthermore, because each transmission thread can simultaneously process multiple transmission requests from multiple worker threads, the overall number of threads that are active over a given time period can be reduced.

As seen in FIG. 1, a user equipment 101 is connected to a server 103 via a communication network 105. The user of the equipment 101 sends a request for information to the server 103 by launching a session client 107 (e.g. a browser application or other information processing application). Within the server 103, one or more listener threads 109a-109j monitor one or more TCP sockets 111a-111n to detect incoming requests (e.g., for web content) from the UE 101. The listener threads 109a-109j redirect any detected requests to the request processor 113. In one embodiment, the thread manager 115, within the request processor 113, then checks a thread pool 117 for an available worker thread 119 that can be either assigned or created to process the new request. For example, if a suitable worker thread 119 is found in the thread pool 117 the request is assigned to it, otherwise the thread manager 115 launches a new worker thread 119 and assigns the request to the new worker thread 119. A worker thread 119 is selected for processing a request based on, for instance, the requesting device's privileges, request history, server status, etc. The worker thread 119 generates a response to the request by collecting information from database 121 and processing the collected data.

In one embodiment, the thread manager 115 periodically monitors the status of active worker threads 119. In another embodiment, the worker threads 119 may send alerts to the thread manager 115 regarding any status changes. For example, a worker thread 119 may send a message to the thread manager 115 indicating completion of response generation for a request.

In one embodiment, upon detecting the status change of the worker thread 119 or receiving the alert from the worker thread, the thread manager 115 creates a transmission thread 123 and delegates the transmission of the response generated by the worker thread 119 to the transmission thread 123. In the approach described herein, the transmission thread 123 may serve any number other worker threads 119. In other words, a single transmission thread 123 may transmit the responses generated by any number of worker threads 119. The number of responses assigned to any one transmission thread 123 can be determined by the thread manager 115, service provider (not shown), operator of the communication network 105, etc., or a combination thereof. By way of example, the determination can be made based on network conditions, type of requests, number of requests, volume of network traffic, and the like. In one embodiment, the transmission thread 123 may be created as a new thread or may be selected from the thread pool 117. As noted, the thread manager 115 assigns the processed response to the new transmission thread 123 in order to be transmitted to the requesting device. At the same time, the thread manager 115 releases the worker thread 119 that created the response by killing the worker thread or by returning the thread to the thread pool 117 for further use. Once the response is delivered, the thread manager 115 either kills the transmission thread or returns the thread to the thread pool 117 for further use.

As shown in FIG. 1, the system 100 enables connectivity between the UE 101 and the thread manager 115 of the server 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like. In certain embodiments, the system 100 may include several servers (e.g., multiple versions of server 103) located in data centers (not shown) having connectivity to the network 105 through general network components such as load balancers (not shown) that distribute the communication load among the servers.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, server 103, and thread manager 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

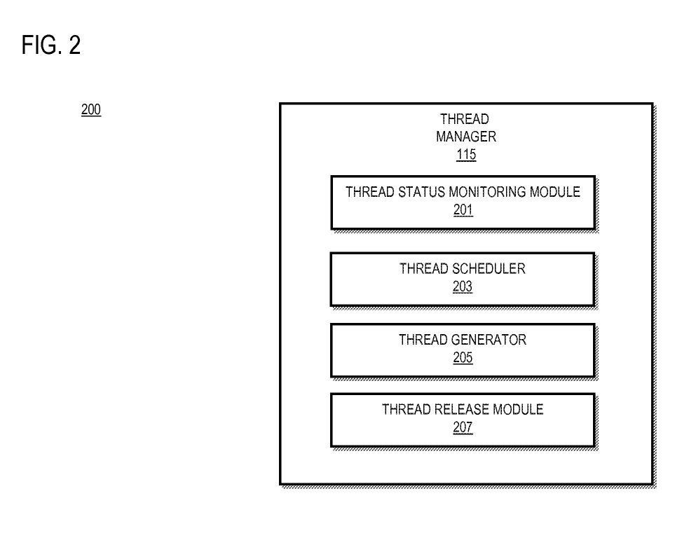

FIG. 2 is a diagram of the components of thread manager, according to one embodiment. By way of example, the thread manager 115 includes one or more components for providing optimization of information transmission techniques. It is contemplated that the functions of these components may be combined in one or more components or performed by other components of equivalent functionality. In this embodiment, the thread manager 115 includes a thread status monitoring module 201, a thread scheduler 203, a thread generator 205, and a thread release module 207.

In one embodiment, the thread monitoring module 201 monitors and maintains the updated status of active worker threads 119 and transmission threads 123. For example a worker thread 119 or a transmission thread 123 may be “available” (i.e., ready to start a new process), “busy” (i.e., processing a request), “idle” (i.e., not in use), etc. The thread monitoring module 201 may check threads status periodically (e.g., by sending a status request message and receiving a return response from each active thread) and update a status table accordingly. Additionally, the worker threads 119 and transmission threads 123 may periodically provide alerts to report any changes in status to the thread status monitoring module 201.

In one embodiment, the thread scheduler 203 receives a thread request from the request processor 113. By way of example, the thread request may specify the type of thread needed for the process (e.g., a worker thread 119 or transmission thread 123). The thread scheduler 203 searches the thread pool 117 for a suitable thread for assigning the thread request. If a thread is found, the thread scheduler 203 assigns the thread to the thread request. Otherwise, if a suitable thread is not found in the thread pool, the thread scheduler 203 sends a request for a new thread to the thread generator 205. The thread generator 205 generates a new thread (e.g., a worker thread 119 or a transmission thread 123) and redirects the thread scheduler 203 to the new thread, for example by returning a link to the new thread to the thread scheduler 203.

Selection of a thread can be based on factors such as requesting device's priority and level of authority, thread availability, server load, available bandwidth, etc. For example, devices may be given priority levels based on their IP addresses. A thread (e.g., a worker thread 119 or a transmission thread 123) is selected from the thread pool 117 based on the mentioned factors and if a thread matching the specific requirements is not found in the pool a new thread with the specific requirements is generated.

In one embodiment, the thread scheduler 203 assigns the thread to the thread request from the request processor 113 and signals the thread status monitoring module 201 to register the new thread with a “busy” status. Following the completion of the process, the request processor 113 hands the thread over to the thread release module 207 of the thread manager 115. On receiving the thread or and identifier of the thread, the thread release module 207 determines either to kill the thread or add the thread to the thread pool 117 by evaluating thread data such as thread history, frequency of use, number and status of other available threads, etc. For example, a thread that is frequently used is added or returned to the thread pool 117 for fast accessibility for future processes, while a thread that is rarely used is killed. This improves accessibility of the threads while optimizing the available capacity of the thread pool 117.

In one embodiment, the thread status monitoring module 201 monitors a worker thread 119 that has been assigned a process by the request processor 113. Following the completion of the process, the worker thread 119 stores the results in the database 121 and signals the request processor 113 about the process completion. Upon receipt of the process completion signal, the request processor 113 generates, for instance, a new request for a transmission thread 123 and sends the request to the thread manager 115. The thread scheduler 203 receives the request for the transmission thread 123 and schedules a transmission thread 123 based on the thread selection process explained above.

In another embodiment, the request processor 113 may delegate the transmission of a process response to a transmission thread 123 for some processes and may leave the transmission of the process response to be performed by the worker thread 119 for some other processes. Assignment of a dedicated transmission thread 123 can depend on factors such as server load, device priorities, request history, etc. Moreover, it is contemplated that the request processor 113 can start transmission of the process response using the worker thread 119 and then transition to transmission of the process response using the transmission thread 123 if, for instance, the transmission by the worker thread is taking too long or does not meet predetermined criteria (e.g., specified Quality of Service, error rate, etc.). In certain embodiments, the determination of whether to delegate a response transmission to the transmission thread 123 can also be determined based on an identifier (e.g., IP address) or characteristic (e.g., mobile device) of the requesting UE 101. For example, the identifier or IP address may indicate to the request processor 113 that the requesting UE 101 is connected via a relatively slow network connection (e.g., a wireless or other low bandwidth connection) that can benefit from the optimized transmission scheme (e.g., use of the dedicated transmission thread 123) as described herein. In yet another embodiment, the thread status monitoring module 201 can monitor the status of the worker thread 119. Then, on detecting completion of the processing of the client request, the thread status monitoring module 201 can change the status of the worker thread 119 to “idle.” In certain embodiments, the thread status monitoring module 201 can also signal the thread release module 207 to release the worker thread as discussed above.

Upon activation or delegation of a process, the transmission thread 123 reads the process results from the database 121 and transmits the results to the requesting device. The thread status monitoring module 201 monitors the transmission thread 123 that has been assigned the transmission process by the request processor 113. Following the completion of the transmission process, the transmission thread signals the request processor 113 about the transmission completion. The thread status monitoring module 201 can then, for instance, change the status of the transmission thread to “idle” and signal the thread release module 207 to release the transmission thread. The thread release module 207 releases the transmission thread 123 after analysis of its history as explained above.

In one embodiment, the thread scheduler 203 may combine results for two or more client requests or processes for delegation to and transmission by a single transmission thread 123. As noted previously, the delegation of the results from multiple worker threads 119 to one transmission thread 123 advantageously enables the worker threads 119 to be reassigned to other processes more quickly, thereby enabling the web server 103 to handle more requests.

In another embodiment, the thread scheduler 203 may divide each of the process results for a set of requests into two or more partitions and transmit every partition using a transmission thread 123 or combine partitions of different results to be transmitted together. In such cases the thread scheduler assigns identifiers to each partition showing the relation between partitions so that the requesting device can recombine them into the complete result.

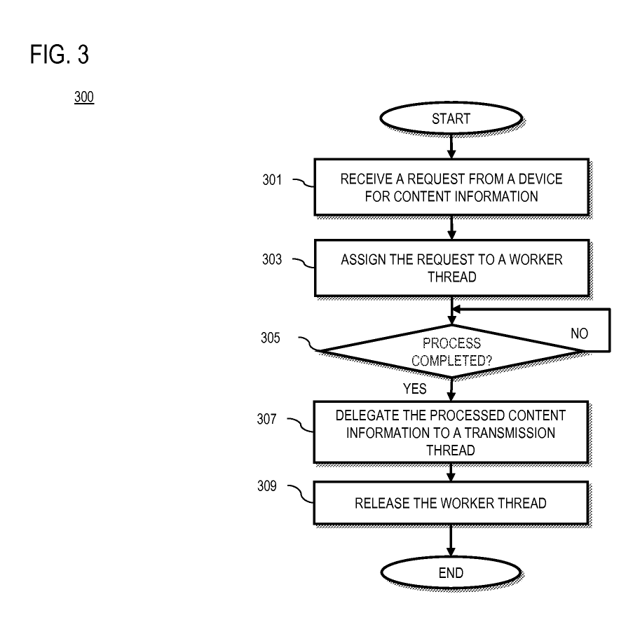

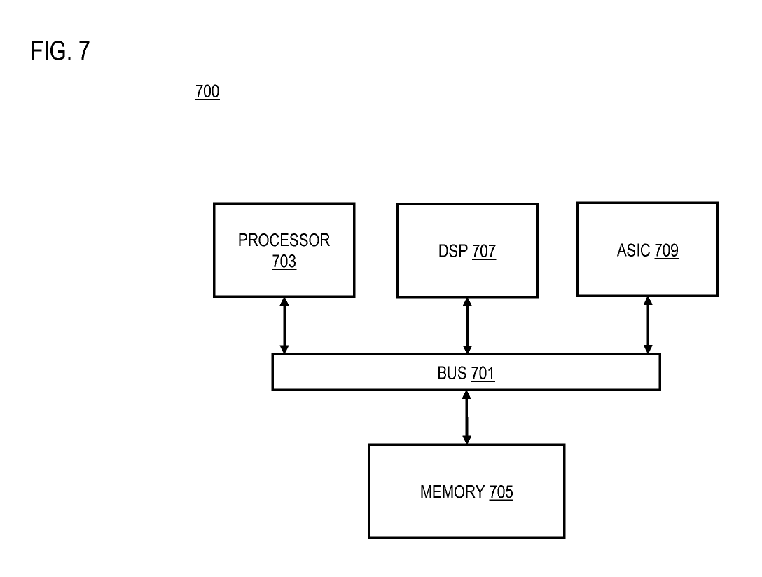

FIG. 3 is a flowchart of a process for providing optimized information transmission using dedicated threads, according to one embodiment. In one embodiment, the thread manager 115 performs the process 300 and is implemented in, for instance, a chip set including a processor and a memory as shown FIG. 7. In step 301, the thread manager 115 receives a request for content information that has been sent by a device (e.g., the UE 101). Upon receiving the request, the thread scheduler 203 either selects a worker thread 119 from the thread pool 117 or activates the thread generator 205 for generating a new worker thread 119. After selecting or creating the worker thread 119, the thread manager 115 assigns the request to the worker thread 119 per step 303. In step 305, the thread manager 115 monitors the worker thread 119 until the process by worker thread 119 is completed. Once the process is completed, in step 307, the results of the process are delegated to a transmission thread 123 for transmission to the requesting device. In step 309, the thread manager 115 releases the thread.

In one embodiment, the thread manager utilizes information such as requesting device characteristics and priorities to decide whether the transmission of request results to the device is delegated to a dedicated transmission thread 123 or whether the transmission can be performed by the worker thread 119 that initially processed the client request. For example, if there are no pending requests waiting to be processed, the worker thread 119 that processed the results may transmit the results to the requesting device.

In certain embodiments, assignment of a dedicated transmission thread 123 causes the release of the worker threads following completion of the request process so that the total number of active threads is reduced. Furthermore, while the process results are being transmitted to the requesting device by the transmission thread 123 and the worker thread 119 can be assigned another process.

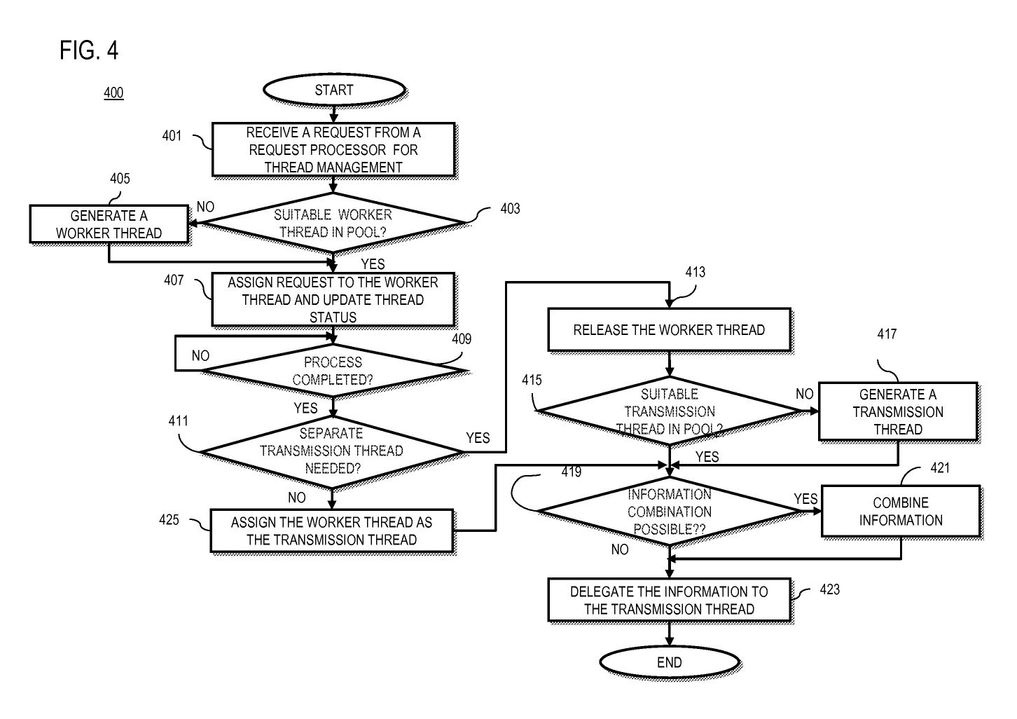

FIG. 4 is a flowchart of a thread management process for providing optimized information transmission using dedicated threads, according to one embodiment. In one embodiment, the thread manager 115 performs the process 400 and is implemented in, for instance, a chip set including a processor and a memory as shown FIG. 7. In step 401, the thread manager 115 receives a request from the request processor 113 for managing the threads that process a request that the request processor has received from a device. In step 403, the thread scheduler 203 searches the thread pool 117 for any suitable worker threads to process device's request. As discussed previously, selection of a worker thread 119 can be based on factors such as requesting device's priority and level of authority, thread availability, server load, available bandwidth, etc.

For example, devices may be given priority levels (e.g., for determining whether to use a dedicated transmission thread 123 or worker thread 119 to transmit a response) based on their IP addresses. By way of example, the IP address may associate a device (e.g., UE 101) with a particular characteristic (e.g., an affiliation such as belonging to a hospital), a network (e.g., wireless network), and/or another other property of the UE 101 or connection to the network 105. In one example, a request for information about a certain type of medication is initiated from an IP address belonging to a hospital. As a result, the request from the hospital may have a higher priority and, therefore, the resulting response may be delegated to a dedicated transmission thread 123, when compared to a request for the same information initiated from an online store. It is contemplated that any identifier of the device or UE 101 (e.g., a UserAgent header of the session client 107) may be used to uniquely identify the UE 101 and/or the characteristics of the UE 101. Continuing with the example, the thread manager 115 may assign the request initiated from a hospital to a worker thread 119 and/or transmission thread 123 with certain specifications (e.g., processing cycles, dedicated bandwidth, available network resources, etc.). If such a thread does not, for instance, exist in the thread pool 117, the thread manager 115 may generate a thread as per step 405. In step 407, the thread manager 115 assigns the request to the worker thread 119 and sets the status of the worker thread 119 to “busy”.

Per step 409, the thread manager 115 monitors the progress of the worker thread 119 until the process is completed. Once the process is completed and a response for the request is provided, per step 411, the thread manager 115 determines whether a separate dedicated transmission thread 123 is to be used for transmission of the resulting response. The determination is based on various factors similar to the decision factors affecting the selection of the worker thread. For example, if there is a high load of requests on the server the thread scheduler may utilize a transmission thread for transmission of the results so that the worker thread can be released and assigned to another request. In such case per step 413 the thread release module 207 releases the worker thread. In step 415 the thread scheduler 203 searches in the thread pool for a suitable transmission thread. The factors affecting the selection of a transmission thread are similar to the factors for selection 403 and decision 411. If a suitable thread is not found in the thread pool per step 417 the thread generator 205 generates a new transmission thread.

In one embodiment, the thread manager 115 may make a determination to use a dedicated transmission thread 123 even after starting transmission using the worker thread 119. For example, the thread manager 115 starts transmission of a response using the worker thread 119 and begins the monitoring the progress of the transmission. If the response contains, for instance, rich content (e.g., audio, video, multimedia, images, etc.) that can be large in size, the transmission of the response can involve a significant amount of data and/or take a significant amount of time. Accordingly, the thread manager 115 can monitor the progress or status of the transfer by the worker thread 119. This status can indicate, for instance, progress towards completion of the transfer, time elapsed, error rate, and the like. The thread manager 115 can then compare the monitored status against predetermined criteria (e.g., maximum elapsed time, maximum number of transmission errors, etc.). If the status indicates that one or more of the monitored status items (e.g., elapsed transfer time) exceeds a predetermined transfer time, the thread manager 115 can determine to delegate all or just the remaining amount of data to transfer to the dedicated transmission thread 123.

Furthermore, in certain embodiments, the thread manager 115 may combine information into clusters to be transmitted by the transmission thread 123. In step 419, the thread manager 115 checks whether combination possibilities exist. For example, the results may be combined based on the destination address (e.g., the IP address of the receiving device). The results that are being sent to the same address may then be combined and transmitted using the same transmission thread 123 (step 421). Next, in step 423, the thread manager 115 delegates the information to the transmission thread 123 to be sent to the requesting device.

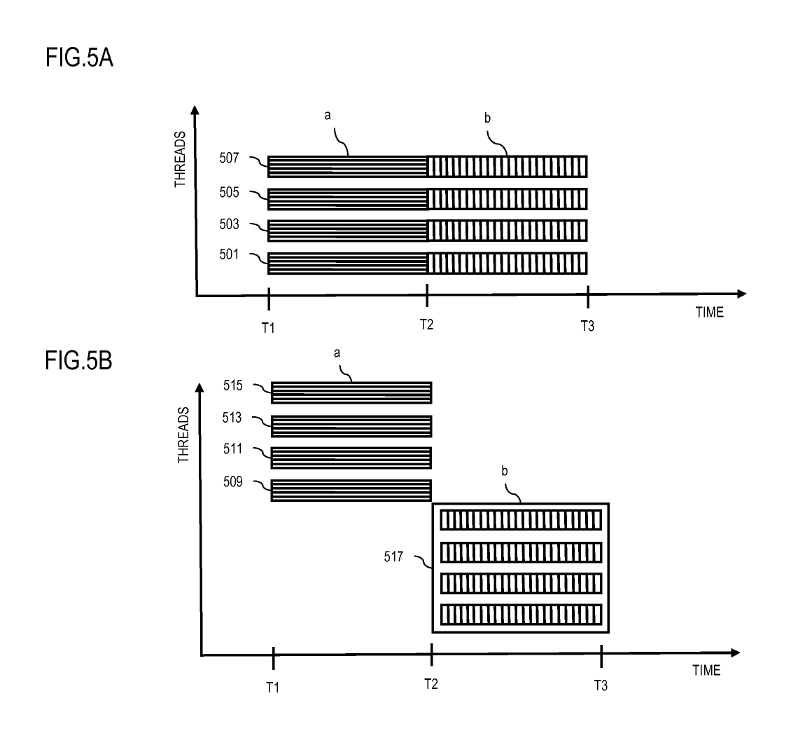

FIGS. 5A-5B illustrate utilization of transmission threads, according to various embodiments. FIG. 5A illustrates an example of a traditional server where a worker thread 119 processes the request and transmits the results. As shown in FIG. 5A, four worker threads 501, 503, 505 and 507 start processing four concurrent requests of column a at time T1. The process is completed at time T2, and the worker threads 501-507 start transmitting results (as shown in column b) at time T1. The transmission is completed at time T2. As an example, if the server 103 takes one second for response generation (T2−T1=1) and one second for response transmission (T3−T2=1) for each of the four threads, there are four worker threads at both first and second seconds of FIG. 5A. Therefore, the average number of threads at server is of FIG. 5A is (4+4)/2=4 for each second.

FIG. 5B illustrates a case where a dedicated transmission thread is used. The column a of FIG. 5B list four worker threads 509, 511, 513, and 515 that a similar to the worker threads in column a of FIG. 5A. In this example, the four worker threads 509, 511, 513 and 515 start processing four concurrent requests of column a at time T1. The process is completed at time T2, assuming that the time stamps T1, T2 and T3 are the same as FIG. 5A. However, in column b of FIG. 5B, a transmission thread 517 transmits results for all the four responses simultaneously. As discussed previously, it is noted that the transmission speeds typically lag behind the computational speeds for generating the results at the web server. Accordingly, the transmission thread 517 can, for instance, collect and group multiple responses for transmission at the same time. In this example, there are four active threads in the one second between times T1 and T2 while only one active thread exists between T2 and T3. Therefore, the average number of active threads from T1 to T3 is (4+1)/2=2.5 per second.

As seen, utilization of a transmission thread over a two seconds process reduces the average number of active threads from 4 to 2.5. If a web server allows 200 active threads at a time, the overall saving of thread times by using transmission threads can be substantial.

The processes described herein for providing optimized information transmission using dedicated threads may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

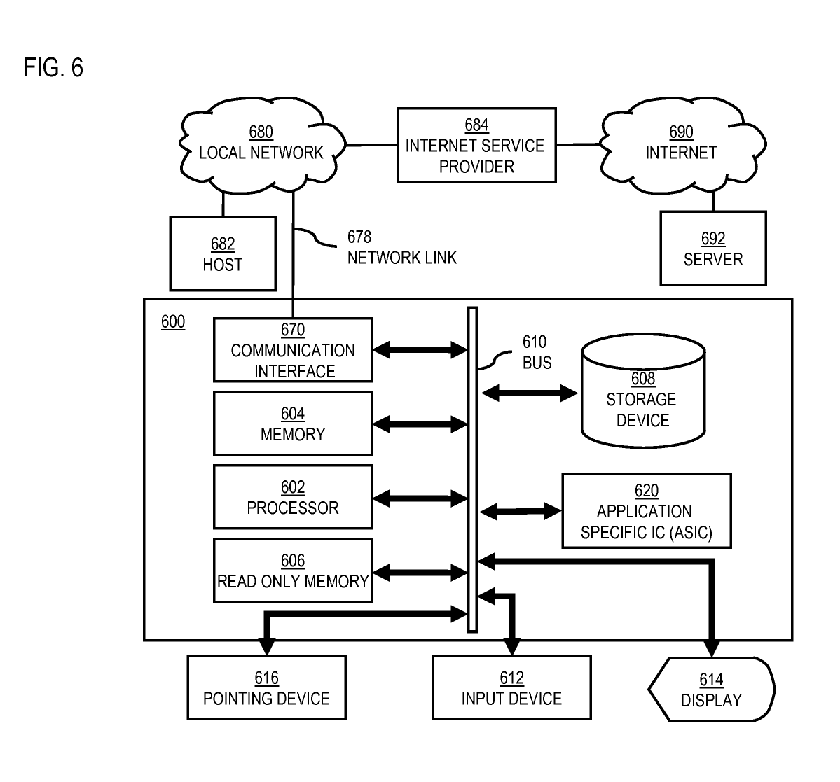

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide optimized information transmission using dedicated threads as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing optimized information transmission using dedicated threads.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to providing optimized information transmission using dedicated threads. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing optimized information transmission using dedicated threads. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing optimized information transmission using dedicated threads, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing optimized information transmission using dedicated threads to the UE 101.

The term “computer-readable medium” as used herein to refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to provide optimized information transmission using dedicated threads as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of providing optimized information transmission using dedicated threads.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide optimized information transmission using dedicated threads. The memory 705 also stores the data associated with or generated by the execution of the inventive steps.

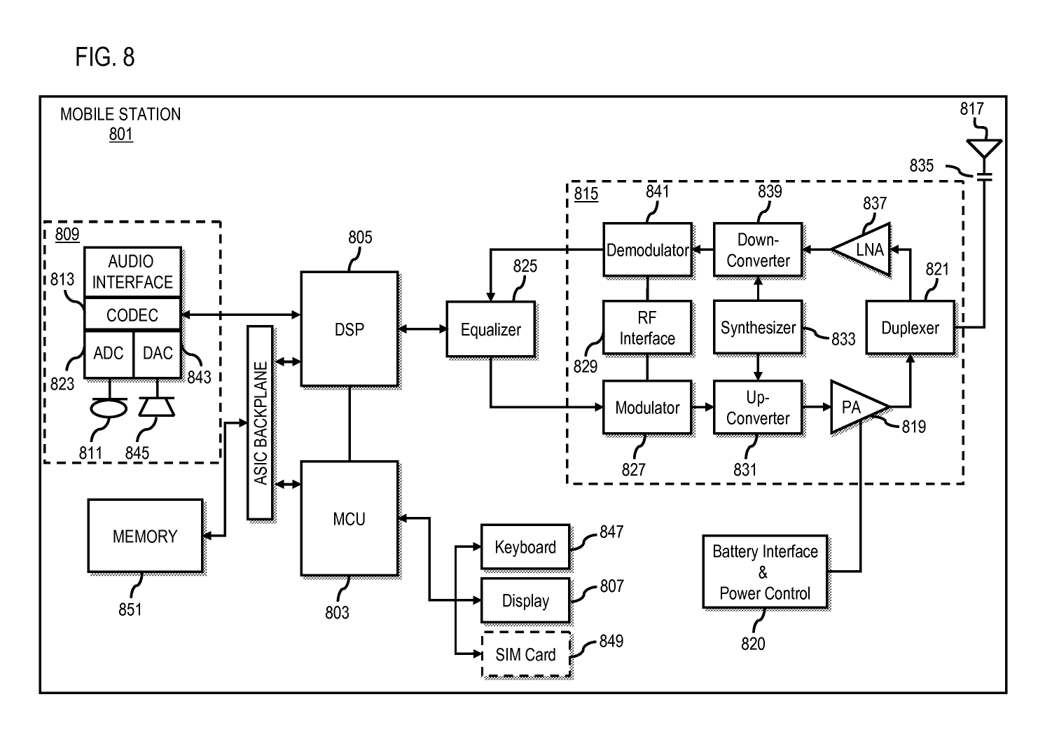

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of providing optimized information transmission using dedicated threads. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing optimized information transmission using dedicated threads. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide optimized information transmission using dedicated threads. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request from a device for content information;
assigning the request to a worker thread for processing to generate the content information;
determining whether the worker thread has completed the processing of the content information;
delegating the processed content information to a transmission thread based, at least in part, on the determination, wherein the transmission thread causes, at least in part, transfer of the processed content information; and
releasing the worker thread from the assigned request.

2. A method of claim 1, wherein the transmission thread transfers a plurality of processed content information, and wherein each of the plurality of processed content information is generated in response to a different request processed by the worker thread, a plurality of other worker threads, or a combination thereof.

3. A method of claim 2, wherein the transfers of the plurality of processed content information occurs simultaneously.

4. A method of claim 1, further comprising:
retrieving an identifier associated with the device; and
determining whether to delegate the processed content information to the transmission thread based, at least in part, on the identifier.

5. A method of claim 1, wherein the worker thread causes, at least in part, transfer of the processed content information before the delegating of the processed content information to the transmission thread, the method further comprising:
determining a status of the transfer by the worker thread; and
comparing the status against predetermined criteria,
wherein the delegating of the processed content information to the transmission thread is based, at least in part, on the comparison.

6. A method claim 1, further comprising:
determining one or more communication characteristics of a client receiving the transfer of the processed content,
wherein the delegating of the processed content information to the transmission thread is based, at least in part, on the one or more communication characteristics.

7. A method of claim 1, further comprising:
killing the worker thread following the processing of the content.

8. A method of claim 1, further comprising:
assigning another request for content information to the worker thread following the processing of the content.

9. An apparatus comprising:
at least one processor; and
at least one memory including computer program code,
the at least one memory and the computer program code configured to, with the at least one processor, cause the apparatus to perform at least the following,
receive a request from a device for content information;
assign the request to a worker thread for processing to generate the content information;
determine whether the worker thread has completed the processing of the content information;
delegate the processed content information to a transmission thread based, at least in part, on the determination, wherein the transmission thread causes, at least in part, transfer of the processed content information; and
release the worker thread from the assigned request.

10. An apparatus of claim 9, wherein the transmission thread transfers a plurality of processed content information, and wherein each of the plurality of processed content information is generated in response to a different request processed by the worker thread, a plurality of other worker threads, or a combination thereof

11. An apparatus of claim 9, wherein the transfers of the plurality of processed content information occurs simultaneously.

12. An apparatus of claim 9, wherein the apparatus is caused to further perform:
retrieving an identifier associated with the device; and
determining whether to delegate the processed content information to the transmission thread based, at least in part, on the identifier.

13. An apparatus of claim 9, wherein the worker thread causes, at least in part, transfer of the processed content information before the delegating of the processed content information to the transmission thread, and the apparatus is caused to further perform:
determining a status of the transfer by the worker thread; and
comparing the status against predetermined criteria,
wherein the delegating of the processed content information to the transmission thread is based, at least in part, on the comparison.

14. An apparatus claim 9, wherein the apparatus is caused to further perform:
determining one or more communication characteristics of a client receiving the transfer of the processed content,
wherein the delegating of the processed content information to the transmission thread is based, at least in part, on the one or more communication characteristics.

15. An apparatus of claim 9, wherein the apparatus is caused to further perform:
killing the worker thread following the processing of the content.

16. An apparatus of claim 9, wherein the apparatus is caused to further perform:
assigning another request for content information to the worker thread following the processing of the content.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
receiving a request from a device for content information;
assigning the request to a worker thread for processing to generate the content information;
determining whether the worker thread has completed the processing of the content information;
delegating the processed content information to a transmission thread based, at least in part, on the determination, wherein the transmission thread causes, at least in part, transfer of the processed content information; and
releasing the worker thread from the assigned request.

19. A computer-readable storage medium of claim 18, wherein the transmission thread transfers a plurality of processed content information, and wherein each of the plurality of processed content information is generated in response to a different request processed by the worker thread, a plurality of other worker threads, or a combination thereof.

20. A computer-readable storage medium of claim 19, wherein the worker thread causes, at least in part, transfer of the processed content information before the delegating of the processed content information to the transmission thread, and the apparatus is caused to further perform:
determining a status of the transfer by the worker thread; and
comparing the status against predetermined criteria,
wherein the delegating of the processed content information to the transmission thread is based, at least in part, on the comparison.
